(19) United States
(12) Patent Application Publication
(10) Pub. No.: US 2007/0035921 A1
(43) Pub. Date: Feb. 15, 2007

(54) Frame structure for floppy disk drive

(75) Inventor: Jui-Lin Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/395,640

(22) Filed: Mar. 31, 2006

(30) Foreign Application Priority Data
Aug. 12, 2005 (TW) 094213802

(51) Int. Cl. G06F 1/16

(52) U.S. Cl. 361/685

(57) ABSTRACT

A frame structure for a floppy disk drive includes a frame body for fastening the floppy disk drive, and a pulling member assembled on the frame body for users to easily pull out the floppy disk drive connected with the frame body without inserting hands into the server. Therefore, potential damages to the internal chips caused by the contact of hands carrying the static electricity, or incidents of the users' hands getting burned by the high-temperature heat-dissipation chip inside of the server, can be prevented.

### FIELD OF THE INVENTION

The present invention relates to systems for installation and removal of a floppy disk drive, and more particularly, to a frame structure that allows a user to install or remove a floppy disk drive from a server in a convenient manner.

### BACKGROUND OF THE INVENTION

As a result of rapid technological progress, the value and use of information continues to increase and individuals and businesses seek additional ways to process and store information. One option available to users is computer systems which have become indispensable to modem life. A computer system generally processes, compiles, stores, and/or communicates information or data for business, personal, or other purposes thereby allowing users to take advantage of the value of the information. A floppy disk drive is a convenient storage device for saving software programs for computer applications and is connected to a computer unit for reading the contents of data saved in a floppy disk, which is a most common data exchange media and widely used among users due to its low price, portability and repeated use of read-and-write function.

FIG. 1 depicts a prior art floppy disk drive frame 1 often-seen on the market, as shown in the drawing, a plurality of screw bores 11 is typically formed on both sides of the floppy disk to be fixed to a computer mainframe, on which a frame structure for storing the floppy disk drive therein (not shown) is provided, wherein the wall surfaces of both edges of the frame structure are formed with a plurality of bores (not shown), and a receptacle (not shown) is disposed on the computer unit for receiving the floppy disk drive therein, whereby the floppy disk drive is directly fixed to a computer base through screw bores 11 and the bores formed on the frame structure.

As the use of servers becomes popular along with the rapid development of networking technology, a server equals to a regular computer unit but is equipped with greater functionality which often has stronger capability in processing and saving data. Similarly, a server still requires using a disk drive or a floppy disk drive for installation of software and updates of software versions, and the installation of a disk drive or a floppy disk drive is similar to that of a regular computer. In maintenance, it is necessary to open a server to replace the damaged electronic devices installed in the sever, particularly more often for a floppy disk drive that needs to be replaced when its reading capability becomes inefficient. The prior art floppy disk drive frame/hard disk drive frame is buckled to a computer base by screws. That is, the floppy disk drive frame/hard disk drive frame is directly screwed and fixed to a computer base. Since in this operation, screw opener is necessary in operation, the speed in assembly and maintenance is reduced, and the maintenance cost is therefore increased. The typical way to disassemble a floppy disk drive is first to dismantle screws that fixed the floppy disk drive, and then use a hand to reach out into the machinery box located behind the floppy disk drive and exert some forces to push out a small portion of the drive from the receptacle, and lastly use another free hand to hold the push-out portion so as to take out the entire floppy disk drive.

As the demand for a compact server is high, the general design of a server often does not allow a software technician to take out the floppy disk drive easily by hands because of the limited space. In the prior art disassembling method where a software technician is required to reach out into the server by hands in order to take out the drive, the user's hands may easily contact the chips or the heat-dissipation slice contained therein and damage the chips as a result because of the static electricity carried by human hands or get burned by the heat-dissipation slice working at high-temperature.

Therefore, there exists a need to provide an effective device to facilitate storage and removal of the floppy disk drive from a conventional computer or server which has limited space and does not necessitate a manual operation.

### SUMMARY OF THE INVENTION

In light of the foregoing drawbacks in the prior art, a primary objective of the present invention is to provide a frame structure for a floppy disk drive, which has a pulling member that allows a user to easily remove the floppy disk drive from a server.

Another primary objective of the present invention is to provide a frame structure for a floppy disk drive, which allows a user to easily remove the floppy disk drive from a server without inserting hands thereto, so as to prevent accidents of a user's hands from getting burned by internal components of the server at high temperature.

In accordance with the foregoing and other objectives, the invention proposes a novel frame structure for a floppy disk drive, comprising: a frame body for fastening a floppy disk drive in a server, and a pulling member connected with the frame body to allow a user to pull out the frame body towards the user, wherein the frame body may be a metal frame work having a thin board and the pulling member may be a metal slice.

The frame body is a board having two sides bent perpendicularly to form a U-shaped structure, wherein the bottom of the frame body further comprises a concave groove adapted to receive a protruding portion formed in the bottom of the floppy disk drive. The frame body is made to correspond to the design of an drive bay of the server, so as to facilitate installation and removal of the floppy disk drive in the server.

The frame body is formed with a plurality of bores in positions corresponding to the plurality of locking bores formed at predetermined positions of the floppy disk drive, such that the bores subsequently penetrated by screwing members are coupled to the locking bores so as to fasten the floppy disk drive to the frame body.

The pulling member may be formed with a through hole so that a user can put fingers therein to pull out the floppy disk. Further, as the pulling member is bolted to the frame body and thus can be rotated to serve as a medium for the user to remove the floppy disk drive from the server, or to put away the pulling member and store it in the frame body as needed. Furthermore, the frame body may further comprise a blocking portion used to restrict the rotation range of the pulling member, and the pulling member may further comprise a limiting portion that works in coordination with the blocking portion to limit the rotation range of the pulling member for storage.

Summarizing the above, a frame structure for a floppy disk drive proposed by the present invention is implemented by employing a frame body to fasten the floppy disk drive and a pulling member that allows a user to conveniently remove the floppy disk drive from a server by first rotating the pulling member to a certain position and then exerting an appropriate force on the pulling member to pull out the floppy disk drive. Compared to the prior art techniques, the pulling member proposed by the present invention can facilitate removal of the floppy disk drive without the necessity of having an extra space reserved on behind the floppy disk drive for the purpose and convenience of removing the drive therefrom that may otherwise adversely increase the size of the server box. Consequently, it is not necessary for a user to reach hands into the server box in order to push or pull out the floppy disk drive, thereby preventing damages to the internal chips caused by the contact of hands carrying the static electricity, or incidents of a user's hands getting burned by the high-temperature heat-dissipation chip inside of the server. Therefore, the present invention offers advantages over the prior art and can ensure the safety as well as the convenience of removing the floppy disk drive from a server or a computer as needed.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing a conventional method of fastening a floppy disk drive to a computer;

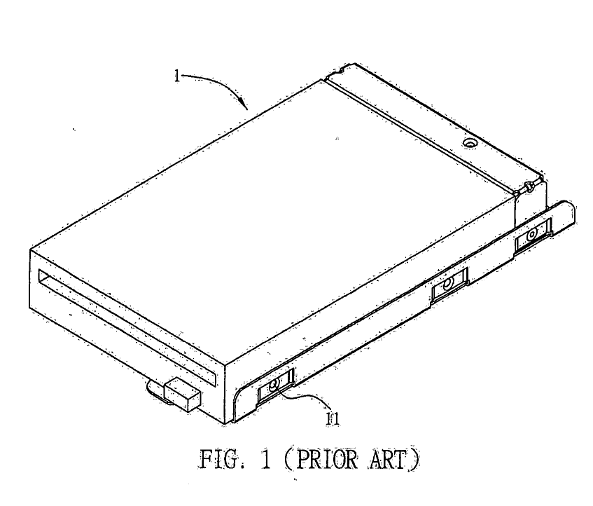

FIG. 2 is a schematic diagram showing a first preferred embodiment of the floppy disk drive frame structure according to the present invention; and

FIG. 3 is a schematic diagram showing a second preferred embodiment of the floppy disk drive frame structure according to the present invention.

### DETAILED DESCRIPTION OF PREFERRED EMBODIMENTS

The present invention is described in the following with specific embodiments, so that one skilled in the pertinent art can easily understand other advantages and effects of the present invention. The present invention may also be implemented and applied according to other embodiments, for example, the frame body and the pulling member thereof in the preferred embodiment is made of a metallic material, which can also be made of plastic or other materials, provided that the material used has the sufficient strength for fastening purposes.

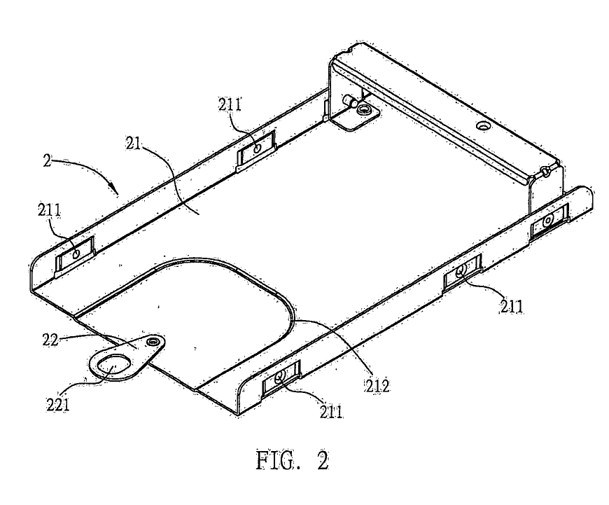

FIG. 2 illustrates a first preferred embodiment of the floppy disk drive frame structure according to the invention. As shown, the floppy disk drive frame structure 2 of the invention comprises a frame body 21 used to connect with a floppy disk drive (not shown) so that the floppy disk drive can be fastened thereon; and a pulling member 22 connected with the frame body 21 for allowing a user to pull out the frame body 21 along with the floppy disk stored therein via the pulling member 22.

The frame body 21 is adapted to fasten the floppy disk drive (not shown) thereon, the frame body 21 being the shape of a U-shaped structure formed by bending vertically and upwardly a left and a right side thereof, such that the floppy disk drive can be accommodated therein. Further, the frame body 21 is made to correspond to the design of an drive bay of the server so that the floppy disk drive can be installed in or taken out from the server easily.

In this embodiment, two bent-upwardly sides of the frame body 21 is formed with a plurality of through bores 211 which corresponds to the plurality of locking bores (not shown) formed at a predetermined position of the floppy disk drive, whereby the floppy disk drive is connected to the frame body 21 by screws (not shown) penetrating the through bores 211 and the locking bores. Note that the floppy disk drive not only can be fastened to the frame body 21 by locking bores and screws, but also it can be fastened by wedged or other means so long as it fits the purpose well.

The pulling member 22 is an immobile thin metal slice installed on the frame body 21, wherein the pulling member 22 is formed with a through hole 221 so that a user can exert force by putting fingers therein to pull out the floppy disk. Note that the pulling member 22 can also be a hook or other shapes for exerting forces thereon.

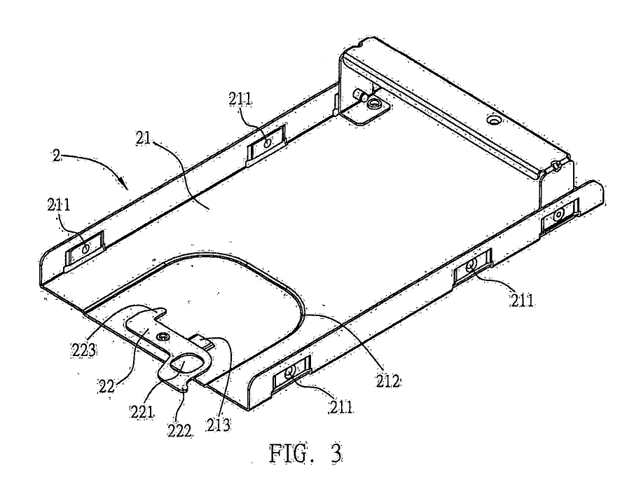

FIG. 3 illustrates a second preferred embodiment of the floppy disk drive frame structure according to the invention. As shown, the floppy disk drive frame structure 2 of this embodiment is substantially the same as that of the first embodiment, it only differs in that the pulling member 22 is pivotally rotatable on the frame body 21, so that the pulling member 22 can be rotated into a concave groove 212 for storage when not in use to save the space. In addition, the frame body 21 is further provided with a blocking portion 213, which is used to block and restrict the pulling member 22 from excess rotation when a user rotates to store away the pulling member, while the pulling member 22 can further include an extension portion 222, whereby the pulling member 22 can be conveniently rotated and pulled out to an appropriate position for allowing a user's fingers to put in the through hole 221 to use the pulling member 22 in storage.

Further, the pulling member 22 can also include a limiting portion 223 that works in coordination with the blocking portion 213 to limit the rotation range of the pulling member when a user rotates outwardly the pulling member 22 to take out the floppy disk drive.

Summarizing the above, the floppy disk drive frame structure of the present invention provides a pulling member that allows the user to take put the floppy disk from a server easily. As it is not necessary to reserve a space on behind the floppy disk drive for the consideration of taking out the drive therefrom, thus a more compact size server box can be realized. Besides, in the process of taking out the floppy disk drive, it does not require a user's hands to reach into the server box for pushing out the floppy disk drive, such that potential damages to the internal chips caused by the contact of hands carrying the static electricity, or incidents of a user's hands getting burned by the high-temperature heat-dissipation chip inside of the server can be prevented. Therefore, the present invention offers advantages over the prior art in that it can ensure the safety as well as the convenience of removing the floppy disk drive from a server/computer as needed.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A frame structure for a floppy disk drive, comprising:
a frame body for fastening the floppy disk drive, and
a pulling member assembled on the frame body, allowing a user to remove the floppy disk drive connected with the frame body by pulling the pulling member.

2. The frame structure of claim 1, wherein the frame body is a framework having a board with two sides bent perpendicularly to form a U-shaped structure corresponding to a drive bay design of the server, so as to facilitate installation and removal of the floppy disk drive in a server.

3. The frame structure of claim 1, wherein the frame body further includes a concave groove for receiving a protruding portion formed in a bottom of the floppy disk drive.

4. The frame structure of claim 1, wherein the frame body is a framework having a thin board.

5. The frame structure of claim 4, wherein the framework is made of metal.

6. The frame structure of claim 1, wherein the frame body is formed with a plurality of bores at positions corresponding to a plurality of locking bores formed at predetermined positions of the floppy disk drive, such that the bores of the frame body penetrated by screwing members are coupled to the locking bores, so as to fasten the floppy disk drive to the frame body.

7. The frame structure of claim 1, wherein the pulling member further comprises a through hole.

8. The frame structure of claim 1, wherein the pulling member is a thin metal slice.

9. The frame structure of claim 1, wherein the pulling member is rotatable in relation to the frame body.

10. The frame structure of claim 1, wherein the pulling member further comprises a limiting portion.

11. The frame structure of claim 10, wherein the frame body further comprises a blocking portion, which works in coordination with the limiting portion of the pulling member to restrict rotation range of the pulling member.
